(19) United States
(12) Patent Application Publication
(10) Pub. No.: US 2015/0339410 A1
(43) Pub. Date: Nov. 26, 2015

(54) CAD COMPONENTS WITH OVERLAY DATA

(71) Applicant: Siemens Product Lifecycle Management Software Inc., Plano, TX (US)

(72) Inventors: Ian Fisher, Long Beach, CA (US); Avijit Sen, Cypress, CA (US)

(73) Assignee: Siemens Product Lifecycle Management Software Inc., Plano, TX (US)

(21) Appl. No.: 14/284,688

(22) Filed: May 22, 2014

(51) Int. Cl. G06F 17/50

(52) U.S. Cl. CPC G06F 17/50

(57) ABSTRACT

Methods for product data management and corresponding systems and computer-readable mediums. A method includes receiving a computer aided design (CAD) model including a source part and receiving a command to create augmented data for the source part. The method includes creating an augmented part corresponding to the source part and performing at least one CAD operation on the CAD model using at least a portion of data of the source part and using augmented data of the augmented part.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or PDM systems).

### BACKGROUND OF THE DISCLOSURE

PDM systems manage PLM and other data. Improved systems are desirable.

### SUMMARY OF THE DISCLOSURE

Various disclosed embodiments include methods for product data management and corresponding systems and computer-readable mediums. A method includes receiving a computer aided design (CAD) model including a source part and receiving a command to create augmented data for the source part. The method includes creating an augmented part corresponding to the source part and performing at least one CAD operation on the CAD model using at least a portion of data of the source part and using augmented data of the augmented part.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIG. 2 illustrates the use of an augmented part in conjunction with a source part in accordance with disclosed embodiments;

FIG. 3 illustrates a flowchart of a process in accordance with disclosed embodiments.

### DETAILED DESCRIPTION

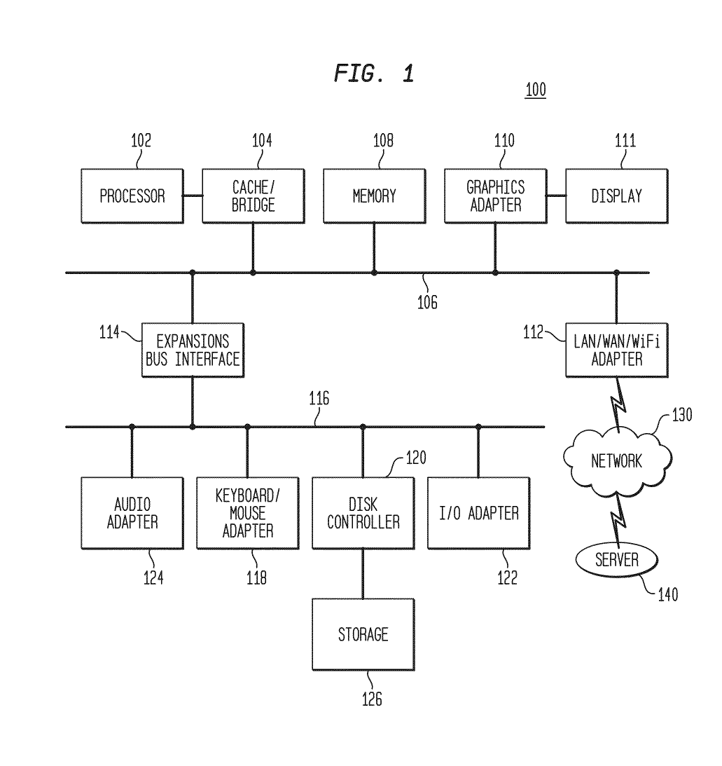

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Managing the very large datasets for assemblies in CAD and PDM systems can be very difficult. Often, there is an imported component in a CAD system that should not be edited but nevertheless needs to be changed or augmented. For example, catalog parts such as standard fasteners may be used in multiple places in an assembly—in such cases each use may require different specific parameters or dimensions, but the standard part definition should not be changed. Disclosed embodiments enable users to create overlay data (such as product manufacturing information (PMI) and augmented geometry) for a component of an assembly in a CAD system used in conjunction with a PDM system. This overlay data is maintained in the system in an “augmented part,” as that term is used herein. According to various embodiments, the dataset of the component is not modified; rather, the overlay data is associated with the component dataset within the PDM system and the combined content is managed by the CAD system. In the context of the catalog part example above, each use of the fastener in the assembly may have different augmented data without changing the standard part definition.

FIG. 1 illustrates a block diagram of a data processing system in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Disclosed embodiments include systems and methods for creating and applying augmented geometry of design elements. Such augmented geometry is associated with the dataset of the design element or other component, but does not modify the component. The augmented geometry can then be used when editing or manipulating the assembly whether in a CAD environment or otherwise, including but not limited to when performing assembly cut operations, functions to promote a body along with any body-modifying features on top of it, and deform operations.

For reuse and subordinate design elements the user can choose which geometry of a design element he wants to work on. The system creates a corresponding augmented geometry in the database, for example as a separate dataset, that is attached to design element being edited. The system can maintain the augmented geometry as an “augmented part” along with the original design element, and can represent the augmented geometry as a separate part; in this sense, the “augmented part” can represent augmented data for a specific geometry, a specific part or component, or otherwise as appropriate. The system can then perform CAD operations by allowing the user to work on the original design element (the “source part” with augmented geometry) or on the augmented part. When using the augmented part, any feature or data of the augmented part that conflicts with the corresponding data of the source part will “override” the data of the source part, and other data of the augmented part will be used in addition to the data of the source part. The geometry override can add a representation of the augmented part at the product level. The underlying source part is unchanged, and the new augmented part is added as an overlay that represents the overridden or augmented body when assembled in the product. This can ensure that only one set of features is displayed at any time, whether in a “feature navigator” view or in a 3D-model view. The user can see the features in the augmented part, the features in the overridden source part, or the combined features of the augmented part and source part, according to the user selection.

Keeping the original source part unchanged can be important in a number of contexts, for example when using supplier parts or released parts or any data that is read-only. A further advantage of disclosed embodiments is that there is no data duplication required. The overlay data in the augmented part is tightly coupled to the source part component being overlaid, and the overlay data only contains overlay content. The data in the component being overlaid is not copied. This provides a significant advantage over creating a full copy of the source part by not requiring the entire data model for the source part to be duplicated in the system.

In some embodiments, specific CAD override commands can cause the system to internally create an augmented part for the operation. Once an augmented part is created, either implicitly or explicitly, any type of content can be added to this part by making it a work part. For example, a pump assembly is used through multiple design elements and there is a need to attach different PMI notes to each of the various design elements. For this scenario, an augmented part can be created for each of the source design elements and the required PMI can be added in the augmented parts.

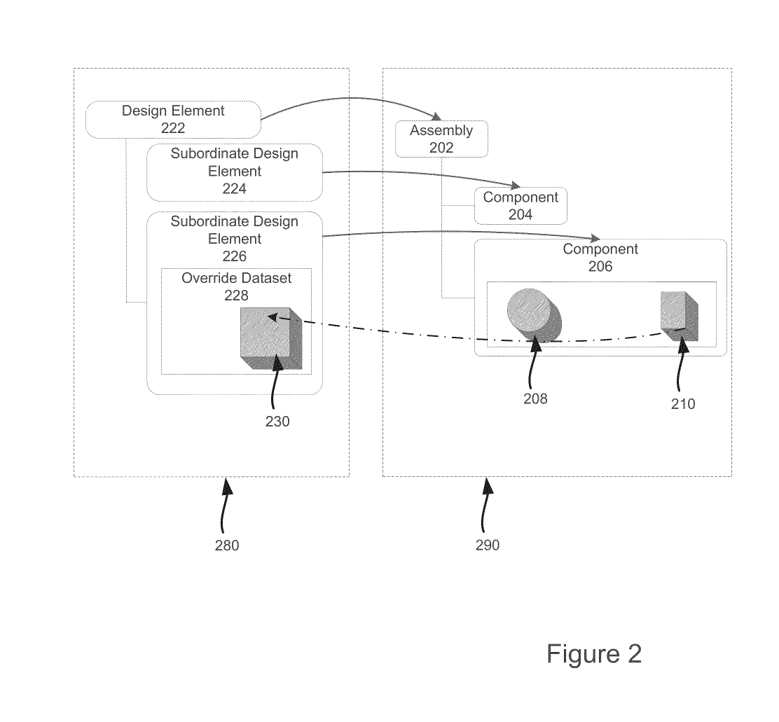

FIG. 2 illustrates the use of an augmented part in conjunction with a source part in accordance with disclosed embodiments. In this figure, the elements indicated by box 280 represent the data maintained by the system for each element in box 290. The elements in box 290 represent the elements in a CAD environment with which the user is working

FIG. 2 illustrates a CAD model of an assembly 202 that has two components, component 204 and component 206. Component 206 has two geometries, cylinder 208 and block 210.

The system also maintains data that corresponds to each of the assembly parts. For example, design element 222 corresponds to assembly 202, subordinate design element 224 corresponds to component 204, and subordinate design element 226 corresponds to component 206.

As described herein, the system can create an augmented dataset 228 for component 206. In this example, the augmented dataset 228 includes an augmented part 230 that corresponds to and augments source part block 210. Note that, in this example, augmented part 230 is larger (changed) from source part 210, since the augmented data in augmented part 230 includes dimensional information that overrides the data of source part 210. Source part 210 is unchanged by the edit that created augmented part 230. The changes stored in augmented part 230 are used in combination with the other properties and data of source part 210. Augmented part 230 is not a substantial copy of source part 210, in that the augmented dataset 228 does not contain copies of unaffected entities in component 206, such as the cylinder. The augmented dataset 228, including the entities which are overridden, may include some data that corresponds to the source part 210 that overrides the source part data, but it does not include copies of unaffected entities.

When performing CAD operations, augmented part 230 can function in place of or in addition to source part 210, and the system can allow a user to edit either of these parts. Edits to the augmented part do not affect the source part 210. The arrow between augmented part 230 and source part 210 represents a defined “override” relationship. When editing augmented part 230, it behaves with characteristics of source part 210 except in aspects that have been expressly overridden. In this way, the augmented part 230 can selectively take the place of source part 210 in the CAD environment indicated by box 290. Since the augmented part 230 is not a substantial copy of source part 210, when the augmented part “takes the place of” the source part, in various embodiments, the system is actually using some of the data of the source part and using the data of the augmented part in addition to or instead of the data of the source part. That is, the data of the augmented part will “override” or augment the corresponding data of the source part. This use can be transparent to the user, so that subsequent use by the user in the CAD environment is as if the user is simply directly manipulating the augmented part 230—the user need never see the overridden aspects of the source part 210 again (unless he so desires). A given model may have multiple identical source parts, each of which has a different corresponding augmented part that is specific to each use.

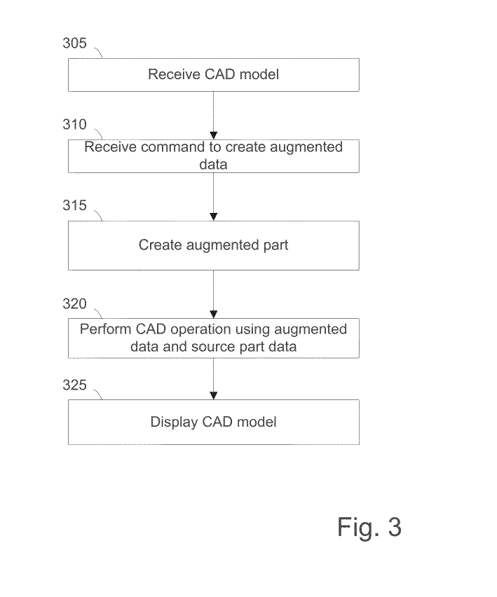

FIG. 3 depicts a flowchart of a process in accordance with disclosed embodiments that may be performed, for example, by one or more CAD, PLM, or PDM systems as described herein, referred to generically as the “system” below.

The system receives a CAD model including a source part (305). The “parts,” in this context, can be any a part or component in an assembly, another CAD object, or otherwise. “Receiving,” as used herein, can include loading from storage, receiving from another device or process, receiving via and interaction with a user, or otherwise.

The system receives a command to create augmented data for the source part (310). The augmented data can be any additional data to be added to the source part, including PMI data, can be changes to the source part including CAD edits to the source part, or otherwise. The command can be a command to perform an operation on the source part that would result in changes to the source part, where changes to the source part cannot or should not be made, where the command therefor implicitly functions as a command to create the augmented data. This command can also be implicit as part of receiving the CAD model—when the CAD model includes augmented data for a source part, the data is automatically “created” in the memory to be used in conjunction with the source part as described herein.

The system creates an augmented part corresponding to the source part (315). The augmented part includes augmented data that is in addition to or overrides at least some data of the source part. The augmented part is not a substantial copy of the source part. As part of this step, the system can also logically couple the augmented part to the source part. The system can otherwise store and maintain the augmented part independently of the source part.

The system thereafter performs at least one CAD operation on the CAD model using at least a portion of data of the source part and using the augmented data of the augmented part (320). This can include but is not limited to performing CAD operations such as assembly cut operations, functions to promote a body along with any body-modifying features on top of it, and deform operations. The augmented data of the augmented part is treated in the same manner by the system as the data of the source part, except that the augmented data overrides the data of the source part when there is a conflict. The use of the augmented part can therefore be transparent to the user. In this manner, the system can perform the CAD operations to effectively modify the source part in the CAD environment by modifying the augmented data and not directly modifying the source part. Of course, in other cases, the operation may only use data from the augmented part independently without using any data from the source part at all.

The system displays the CAD model using at least a portion of data of the source part and using the augmented data of the augmented part (325).

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC §112(f) unless the exact words “means for” are followed by a participle.

What is claimed is:

1. A method performed by a data processing system, comprising:
receiving a computer aided design (CAD) model including a source part;
receiving a command to create augmented data for the source part;
creating an augmented part corresponding to the source part; and
performing at least one CAD operation on the CAD model using at least a portion of data of the source part and using augmented data of the augmented part.

2. The method of claim 1, wherein the system also displays the CAD model using the data of the source part and using the augmented data of the augmented part.

3. The method of claim 1, wherein the CAD operation is one of an assembly cut operation, a functions to promote a body of the CAD model, and a deform operation.

4. The method of claim 1, wherein the augmented part is not a substantial copy of the source part.

5. The method of claim 1, wherein the augmented data overrides the data of the source part when there is a conflict between the augmented data and the data of the source part.

6. The method of claim 1, wherein the system can also logically couple the augmented part to the source part.

7. The method of claim 1, wherein the CAD operation effectively modifies the source part in a CAD environment by modifying the augmented data and not directly modifying the source part.

8. A data processing system comprising:
a processor; and
an accessible memory, the data processing system particularly configured to
receive a computer aided design (CAD) model including a source part;
receive a command to create augmented data for the source part;
create an augmented part corresponding to the source part; and
perform at least one CAD operation on the CAD model using at least a portion of data of the source part and using augmented data of the augmented part.

9. The data processing system of claim 8, wherein the system also displays the CAD model using the data of the source part and using the augmented data of the augmented part.

10. The data processing system of claim 8, wherein the CAD operation is one of an assembly cut operation, a functions to promote a body of the CAD model, and a deform operation.

11. The data processing system of claim 8, wherein the augmented part is not a substantial copy of the source part.

12. The data processing system of claim 8, wherein the augmented data overrides the data of the source part when there is a conflict between the augmented data and the data of the source part.

13. The data processing system of claim 8, wherein the system can also logically couple the augmented part to the source part.

14. The data processing system of claim 8, wherein the CAD operation effectively modifies the source part in a CAD environment by modifying the augmented data and not directly modifying the source part.

15. A non-transitory computer-readable medium encoded with executable instructions that, when executed, cause one or more data processing systems to:
receive a computer aided design (CAD) model including a source part;
receive a command to create augmented data for the source part;
create an augmented part corresponding to the source part; and
perform at least one CAD operation on the CAD model using at least a portion of data of the source part and using augmented data of the augmented part.

16. The computer-readable medium of claim 15, wherein the CAD operation is one of an assembly cut operation, a functions to promote a body of the CAD model, and a deform operation.

17. The computer-readable medium of claim 15, wherein the augmented part is not a substantial copy of the source part.

18. The computer-readable medium of claim 15, wherein the augmented data overrides the data of the source part when there is a conflict between the augmented data and the data of the source part.

19. The computer-readable medium of claim 15, wherein the system can also logically couple the augmented part to the source part.

20. The computer-readable medium of claim 15, wherein the CAD operation effectively modifies the source part in a CAD environment by modifying the augmented data and not directly modifying the source part.
